(19) United States
(12) Patent Application Publication
(10) Pub. No.: US 2026/0365053 A1
(43) Pub. Date: Nov. 19, 2026

(54) MOTOR VEHICLE WITH ELECTRIC PROPULSION EQUIPPED WITH A POWER CABLE OF A BATTERY FOR POWERING THE MOTOR

(71) Applicant: STELLANTIS AUTO SAS, Poissy (FR)

(72) Inventors: Gael GOHIER, Gif Sur Yvette (FR); Nicolas HARLAY, Le Plessis Pate (FR); Xavier ABREU, Maurepas (FR)

(21) Appl. No.: 19/133,595

(22) PCT Filed: Oct. 30, 2023
(86) PCT No.: PCT/FR2023/051708

§ 371 Date: May 28, 2025

(30) Foreign Application Priority Data
Dec. 2, 2022 (FR) 2212666

(51) Int. Cl. B60L 53/18; B60L 50/60; B60L 53/16; B60R 16/02

(52) U.S. Cl. CPC B60L 53/18; B60L 50/60; B60L 53/16; B60R 16/0222

(57) ABSTRACT

The invention relates to a motor vehicle (1) with electric propulsion comprising a metal reinforcement tube (2), said tube opening outwards by an access end (3), a battery for powering a motor, a body (5) provided with an access port (6), a power cable (7) of said battery, said cable being connected to a socket (9) and being configurable between a contracted storage configuration, and a deployed usage configuration, a storage space (10) for storing the cable in the contracted configuration, said space opening onto said access port, said reinforcement tube communicating with said access port and said cable extending into said space and into said tube, passing through said access port, such that said socket is positioned on said access end when said cable is placed in the contracted configuration.

### CROSS-REFERENCE TO RELATED APPLICATIONS

This application is the US National Stage under 35 USC § 371 of International Application No. PCT/FR2023/051708, filed Oct. 30, 2023, which claims the priority of French application No. 2212666 filed on Dec. 2, 2022, the content (text, drawings and claims) of both said applications being incorporated by reference herein.

### BACKGROUND

The described devices relate to a motor vehicle with electric propulsion equipped with a power cable of a battery for powering the motor.

It is known to produce a motor vehicle with electric propulsion—in particular of the “pickup” type—comprising:
a metal box,
at least one metal reinforcement tube mounted on said box, to form a roll bar—in particular to prevent the roof of said vehicle from collapsing when it is overturned in an accident and/or to reinforce the loading space of said vehicle—, said tube opening outwards via at least one end forming an access end,
a battery powering a propulsion motor of said vehicle,
a body provided with an access port,
a power cable of said battery, said cable being connected on both sides to said battery and to a power socket intended to be connected to an external charging device of said battery, said cable being configurable between a retracted storage configuration, when it is not in use, and a deployed usage configuration, where it extends away from said body to allow connection of said socket,
a storage space for storing part of said cable in the retracted configuration, said space being located inside said body and opening onto said access port.

In such an embodiment, the socket is integrated into an external panel of the vehicle body, for example in a fender, which requires the installation of a charging enclosure in said fender, said enclosure being notably closed by a hinged flap aligned with the panel on which it is mounted.

This type of solution is costly and complex to implement; additionally, the flap is visible, and the junction between said flap and the body reveals a gap that breaks with the continuity of the lines of said body, said gap being detrimental in terms of aerodynamics and aesthetics.

### SUMMARY

The aim is to overcome these drawbacks.

To this end, proposed herein is a motor vehicle with electric propulsion comprising:
a metal box,
at least one metal reinforcement tube mounted on said box, to form a roll bar, said tube opening outwards via at least one end forming an access end,
a battery powering a propulsion motor of said vehicle,
a body provided with an access port,
a power cable of said battery, said cable being connected on both sides to said battery and to a power socket intended to be connected to an external charging device of said battery, said cable being configurable between a retracted storage configuration, when it is not in use, and a deployed usage configuration, where it extends away from said body to allow connection of said socket,
a storage space for storing part of said cable in the retracted configuration, said space being located inside said body and opening onto said access port,
   said vehicle further having the following features:
said reinforcement tube communicates with said access port,
said cable extends partly into said space and partly into said reinforcement tube, passing through said access port, so that said socket is positioned on said access end when said cable is brought into the retracted configuration.

It is specified here that throughout the disclosure, spatial positioning terms (lateral, vertical, etc.) are taken to refer to the vehicle in use.

With such an arrangement, the presence of an existing hollow element, namely the reinforcement tube, allows the cable to be run therethrough and out toward the access end; this avoids the use of a body-mounted flap and is advantageous in terms of cost, aerodynamics and aesthetics.

According to one embodiment, the tube is provided in its wall with a communication port located at a distance from its access end, said communication port being located substantially opposite the access port, the cable passing through said communication port to reach said access port.

According to an alternative embodiment, the reinforcement tube comprises a junction end located opposite its access end, said junction end opening outwards to form a communication port, said communication port being located substantially opposite the access port, the cable passing through said communication port to reach said access port.

According to one embodiment, the vehicle further comprises a hollow junction means extending between the access port and the communication port, the cable passing through said junction means, thereby protecting said cable and said access port from impact or attack by fluids or dust.

According to various embodiments, the junction means is in the form of a washer or sleeve.

According to one embodiment, the cable is shaped, at least in part, as a cylindrical helix to form an extensible zone, said cable being provided with an elasticity enabling said extensible zone to be returned under retraction to define the retracted configuration of said cable.

According to an alternative embodiment, the vehicle comprises a winding shaft of the cable to bring it into a retracted configuration, said shaft being returned in the winding direction by a return means.

According to another alternative embodiment, the reinforcement tube portion containing the cable extends along a vertical component, so that said cable is brought into a retracted configuration by the action of gravity, said cable folding back into the retracted configuration at random to form a plurality of loops, thus avoiding the need to provide the cable with elasticity or to provide a winding shaft as described above.

According to one embodiment, when the cable is stored in the storage space in a retracted configuration, the socket is positioned on the access end by insertion into the reinforcement tube, said vehicle further comprising a protective plug for said socket sealing said access end.

### BRIEF DESCRIPTION OF THE DRAWINGS

The described devices will be further detailed by the description of non-limiting embodiments, and based on the appended figures illustrating variants, wherein:

FIG. 1 is a schematic side depiction of a vehicle according to one embodiment, and

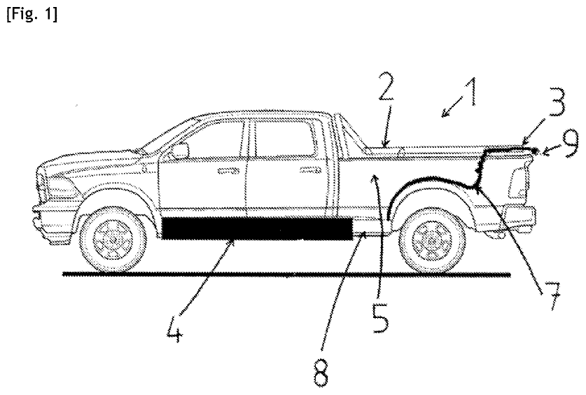

FIG. 2 is a detailed schematic depiction of FIG. 1.

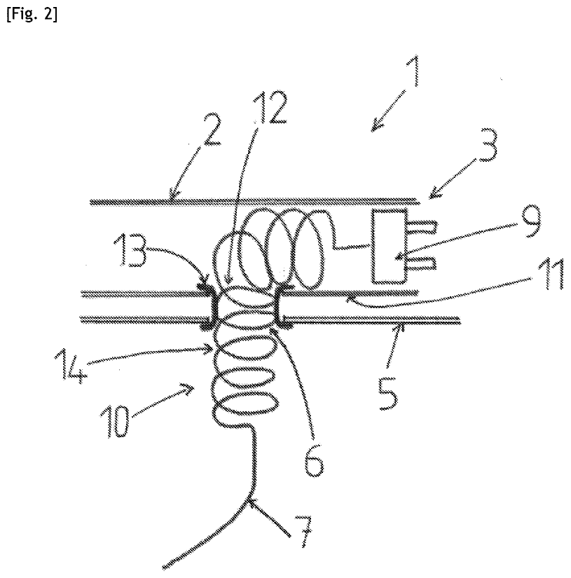

### DETAILED DESCRIPTION

A motor vehicle 1 with electric propulsion will now be described with reference to the figures, comprising:
a metal box, not visible in the figures,
at least one metal reinforcement tube 2 mounted on said box, to form a roll bar, said tube opening outwards via at least one end forming an access end 3,
a battery 4 powering a propulsion motor, not shown, of said vehicle,
a body 5 provided with an access port 6,
a power cable 7 of said battery, said cable being connected on both sides to said battery—here via a charger 8—and to a power socket 9 intended to be connected to an external charging device of said battery, said cable being configurable between a retracted storage configuration, when it is not in use, and a deployed usage configuration, where it extends away from said body to allow connection of said socket,
a storage space 10 for storing part of said cable in the retracted configuration, said space being located inside said body and opening onto said access port,
   said vehicle further having the following features:
said reinforcement tube communicates with said access port,
said cable extends partly into said space and partly into said reinforcement tube, passing through said access port, so that said socket is positioned on said access end when said cable is brought into the retracted configuration.

According to the embodiment shown, the reinforcement tube 2 is provided in its wall 11 with a communication port 12 located at a distance from its access end 3, said communication port being located substantially opposite the access port 6, the cable 7 passing through said communication port to reach said access port.

According to an alternative embodiment not shown, the reinforcement tube 2 comprises a junction end located opposite its access end 3, said junction end opening outwards to form a communication port 12, said communication port being located substantially opposite the access port 6, the cable 7 passing through said communication port to reach said access port.

According to the embodiment shown, the vehicle 1 further comprises a hollow junction means 13 extending between the access port 6 and the communication port 12, the cable 7 passing through said junction means.

According to various embodiments, the junction means 13 is in the form of a washer, according to an embodiment not shown, or a sleeve, according to the embodiment shown, said means being made of rubber, for example.

According to the embodiment shown, the cable 7 is configured, at least in part, as a cylindrical helix to form an extensible zone 14, said cable being provided with an elasticity enabling said extensible zone to be returned under retraction to define the retracted configuration of said cable.

According to an alternative embodiment not shown, the vehicle 1 comprises a cable winding shaft to bring the cable 7 into a retracted configuration, said shaft being returned in the winding direction by a return means, for example in the form of a spring or motor means.

According to another alternative embodiment not shown, the reinforcement tube portion 2 containing the cable 7 extends along a vertical component, so that said cable is brought into a retracted configuration by the action of gravity, said cable folding back into the retracted configuration at random to form a plurality of loops.

According to the embodiment shown, when the cable 7 is stored in the storage space 10 in a retracted configuration, the socket 9 is positioned on the access end 3 by insertion into the reinforcement tube 2, said vehicle further comprising a protective plug, not shown, for said socket sealing said access end.

1. A motor vehicle with electric propulsion, comprising:
a metal box,
at least one metal reinforcement tube mounted on said box, to form a roll bar, said tube opening outwards via at least one end forming an access end,
a battery powering a propulsion motor of said vehicle,
a body provided with an access port,
a power cable of said battery, said cable being connected on both sides to said battery and to a power socket intended to be connected to an external charging device of said battery, said cable being configurable between a retracted storage configuration, when it is not in use, and a deployed usage configuration, where it extends away from said body to allow connection of said socket,
a storage space for storing part of said cable in the retracted configuration, said space being located inside said body and opening onto said access port,
wherein:
said reinforcement tube communicates with said access port,
said cable extends partly into said space and partly into said reinforcement tube, passing through said access port, so that said socket is positioned on said access end when said cable is brought into the retracted configuration.

2. The vehicle according to claim 1, wherein the reinforcement tube is provided in its wall with a communication port located at a distance from its access end, said communication port being located substantially opposite the access port, the cable passing through said communication port to reach said access port.

3. The vehicle according to claim 1, wherein the reinforcement tube comprises a junction end located opposite its access end, said junction end opening outwards to form a communication port, said communication port being located substantially opposite the access port, the cable passing through said communication port to reach said access port.

4. The vehicle according to claim 2, wherein it further comprises a hollow junction means extending between the access port and the communication port, the cable passing through said junction means.

5. The vehicle according to claim 4, wherein the junction means is in the form of a washer or a sleeve.

6. The vehicle according to claim 1, wherein the cable is configured, at least in part, as a cylindrical helix to form an extensible zone, said cable being provided with an elasticity enabling said extensible zone to be returned under retraction to define the retracted configuration of said cable.

7. The vehicle according to claim 1, wherein it comprises a winding shaft of the cable to bring it into a retracted configuration, said shaft being returned in the winding direction by a return means.

8. The vehicle according to claim 1, wherein the reinforcement tube portion containing the cable extends along a vertical component, so that said cable is brought into a retracted configuration by the action of gravity, said cable folding back into the retracted configuration at random to form a plurality of loops.

9. The vehicle according to claim 1, wherein, when the cable is stored in the storage space in a retracted configuration, the socket is positioned on the access end by insertion into the reinforcement tube, said vehicle further comprising a protective plug for said socket sealing said access end.
